(19) United States
(12) Patent Application Publication
(10) Pub. No.: US 2023/0294207 A1
(43) Pub. Date: Sep. 21, 2023

(54) IRRADIATION STRATEGY FOR A COOLABLE, ADDITIVELY MANUFACTURED STRUCTURE

(71) Applicant: Siemens Energy Global GmbH & Co. KG, Munich, Bayern (DE)

(72) Inventors: Johannes Albert, Berlin (DE); Ole Geisen, Berlin (DE); Oliver Hermann, Berlin (DE)

(73) Assignee: Siemens Energy Global GmbH & Co. KG, Munich, Bayern (DE)

(21) Appl. No.: 18/014,785

(22) PCT Filed: Jun. 1, 2021
(86) PCT No.: PCT/EP2021/064623

§ 371 Date: Jan. 6, 2023

(30) Foreign Application Priority Data
Jul. 22, 2020 (DE) 10 2020 209 239.7

(51) Int. Cl. B23K 26/342; B22F 10/85; B22F 10/366; B33Y 50/02

(52) U.S. Cl. CPC B23K 26/342; B22F 10/85; B22F 10/366; B33Y 50/02; B22F 10/28

(57) ABSTRACT

A method for providing manufacturing instructions for the powder-bed-based additive manufacturing of a component includes providing first irradiation vectors for a layer to be additively manufactured, which first irradiation vectors, upon appropriate irradiation by an energy beam, in particular a laser beam or electron beam, cause a porous structure of the layer, as well as providing the first irradiation vectors for a layer which is to be additively manufactured and which follows the layer, in such a way that paths of a porous structure of the layer and of the following layer at least partially overlap in order to allow for a flow through the manufactured component along a build-up direction.

### CROSS REFERENCE TO RELATED APPLICATIONS

This application is the US National Stage of International Application No. PCT/EP2021/064623 filed 1 Jun. 2021, and claims the benefit thereof. The International Application claims the benefit of German Application No. DE 10 2020 209 239.7 filed 22 Jul. 2020. All of the applications are incorporated by reference herein in their entirety.

### FIELD OF INVENTION

The present invention relates to a method for providing manufacturing instructions, in particular instructions for selective irradiation in additive manufacturing, and a corresponding additive manufacturing method. The method for providing manufacturing instructions can be a computer-aided manufacturing method (CAM: “Computer-Aided-Manufacturing”).

Furthermore, an additively manufactured or manufacturable structural part and a computer program or computer program product are specified.

### BACKGROUND OF INVENTION

The structural part is preferably intended for use in the hot gas path of a gas turbine, such as a stationary gas turbine. The structure of the structural part particularly preferably relates to a component of a combustion chamber or a resonator structural part such as a Helmholtz resonator or a part thereof. Alternatively, the structural part may be another coolable or partially porous structural part, such as one used for automotive or aerospace applications.

The structural part is preferably a component to be cooled, for example one coolable via fluid cooling. For this purpose, the structural part preferably has a tailor-made permeability for a corresponding cooling fluid, for example cooling air.

Modern gas turbines are the subject of constant improvement in order to increase their efficiency. However, this leads, among other things, to ever higher temperatures in the hot gas path. The metallic materials for rotor blades, especially in the first stages, are constantly being improved with regard to their strength at high temperatures, creep load, and thermomechanical fatigue.

Due to its disruptive potential for the industry, generative or additive manufacturing is also becoming increasingly interesting for the series manufacturing of the turbine components mentioned above.

Additive manufacturing methods include, for example, as powder bed methods, selective laser melting (SLM) or laser sintering (SLS), or electron beam melting (EBM).

Further additive methods are, for example, “directed energy deposition (DED)” methods, in particular laser deposition welding, electron beam or plasma powder welding, wire welding, metallic powder injection molding, so-called “sheet lamination” methods, or thermal spraying methods (VPS/LPPS, GDCS).

A method for selective laser melting is known, for example, from EP 2 601 006 B 1.

Additive manufacturing methods have furthermore proven to be particularly advantageous for complex components or components of filigree design, for example labyrinth-like structures, cooling structures and/or lightweight structures. In particular, additive manufacturing is advantageous due to a particularly short chain of process steps, since a manufacturing step of a structural part can be carried out largely on the basis of a corresponding CAD file and the selection of corresponding manufacturing and/or irradiation parameters.

A CAD file or a corresponding computer program or computer program product can, for example, be provided or included in the form of a (volatile or non-volatile) storage medium, such as a memory card, a USB stick, a CD-ROM or DVD, or in the form of a file downloadable from a server and/or in a network. The provision may furthermore be realized, for example, in a wireless communication network through the transmission of an appropriate file with the computer program. A computer program (product) may include program code, machine code or numerical control instructions such as G-code and/or other executable program instructions in general.

The manufacturing of gas turbine blades by means of the described powder-bed-based method (“LPBF” for “laser powder bed fusion”) advantageously enables the implementation of new geometries, concepts, solutions and/or design, which can reduce the manufacturing costs or the construction and throughput time, optimize the manufacturing process, and improve, for example, a thermomechanical design or durability of the components.

Blade components manufactured in a conventional manner, for example by casting, are significantly inferior to the additive manufacturing route, for example in terms of their design freedom and also in relation to the required throughput time and the associated high costs as well as the manufacturing effort.

In particular powder-bed-based methods, such as selective laser melting or electron beam melting, further offer the possibility of manufacturing porous structures in a targeted manner through parameter settings or variations. As is well known, the so-called hatching distance in surface-type (selective) irradiation or exposure of a powder layer by an energy beam, such as a laser or electron beam, is, among others, an important parameter which has a particular influence on the obtained structure or porosity of the layer or structural part.

Technically, setting a specific porosity in the material further results in controllable permeability, which can be used, for example, for particularly effective cooling of the resulting structure or component. The permeability, the ability of the cooling fluid to flow through, can further vary depending on the direction in which the structure is built up and on the direction of through-flow. In particular, the permeability is strongly parameter-dependent. In addition to the hatching distance, the irradiance, the scanning speed, the beam focus and the layer thickness can under certain circumstances have an influence on the obtained structure and its porosity. In particular, the laser power correlates strongly with a melt pool depth, i.e. with the dimension that describes the expansion of an initially liquid and then solidifying structure downwards into the powder bed during powder solidification.

A variation in the hatching distance has a significant influence on the flow-through capacity or porosity of a structure along its build-up direction, usually the vertical (z-direction). If, on the other hand, the energy input is reduced, for example, a flattened melt pool is formed, which results in a relatively large lateral porosity.

An additive manufacturing method and corresponding system comprising circular irradiation paths is known, for example, from EP 3 406 370 A1.

The method for manufacturing a three-dimensional object and a corresponding structural part with a specially tailored porosity is known, for example, from WO 2014/202352 A1.

In particular in the case of gas turbine components in the hot gas path, which are subject to high mechanical and thermal loads, an additively manufactured porous structure can be used in a targeted manner to develop advantageous permeability and thus a controlled and significantly more efficient cooling effect.

### SUMMARY OF INVENTION

It is therefore an object of the present invention to expand the range of application of additive manufacturing technologies to the structural parts described or to use material or manufacturing characteristics of additive technologies in a targeted manner for structural advantages and design optimization of the structural parts. This means that not only the conventionally known advantages of additive technologies can be used to advantage. Contrary to the common view held by many experts, according to which the additively achieved structure is weaker and not yet comparable to that of conventionally manufactured structural parts, it is even possible in the present case to achieve an improved structure in a reproducible manner.

This object is achieved by means of the subject matter of the independent patent claims. The dependent patent claims relate to advantageous configurations.

One aspect of the present invention relates to a method for providing manufacturing instructions for the powder-bed-based additive manufacturing of a structural part. The manufacturing instructions preferably relate to the process preparation of the actual manufacturing process, in particular by means of what is known as “computer-aided manufacturing” (CAM).

The method comprises providing first irradiation vectors for a layer to be additively manufactured, which upon corresponding irradiation by an energy beam, in particular a laser or electron beam, brings about an (at least in part) porous structure of the layer along the corresponding vector or path. The irradiation vectors mentioned are preferably chosen to be the same or similar and can form a first irradiation pattern.

The irradiation vectors mentioned preferably represent so-called hatching vectors. Alternatively, they can be contour vectors.

The aforementioned layer to be additively manufactured preferably relates to a raw material layer made of powder which was previously prepared as standard and the selective irradiation of which leads to the formation of a part of a structural part cross section.

The method further comprises providing the aforementioned or similar first irradiation vectors for a layer to be additively manufactured that follows (next) the layer in such a way that paths of a porous structure of the layer and of the following layer overlap at least partially or slightly in the layer plane in order to enable flow through the (finished) manufactured structural part along or obliquely to its build-up direction.

The aforementioned following or next layer (following the first-mentioned layer) is preferably an immediately following layer.

The paths mentioned are intended to denote the course of the irradiation vectors for manufacturing the porous structure in at least some regions of the structural part. In other words, the structural part can be traversed by porous structure profiles through a corresponding selection of the irradiation vectors or paths.

The means described can advantageously be used to manufacture a permeable structure of the structural part, or one that allows flow-through, along and also obliquely to a build-up direction of the structural part (cf. vertical z-direction). In this way, structural part properties which allow subsequent flow through the structural part for efficient cooling during its intended operation can already be defined during process preparation. The degrees of freedom gained in this way can significantly enhance the cooling effect of the entire structural part and also expand its thermal range of application. In the case of turbine structural parts, this furthermore allows the use of higher combustion temperatures and greater energy efficiency of the entire turbomachine.

In one embodiment, the method is or includes a CAM method.

In one configuration, irradiation vectors of the layer and of the following layer overlap in the layer plane by an amount that is smaller than a lateral extent of the paths. As a result, a permeability of a path running diagonally or slightly obliquely in the structural part that is sufficient for a cooling effect can be achieved in a particularly advantageous manner.

In one configuration, the irradiation vectors of the layer and of the following layer completely overlap in the layer plane. As a result of this configuration, a fluid path that is as steep and parallel as possible can advantageously be realized along the build-up direction of the structural part, for example along its longitudinal direction.

In one configuration, the first irradiation vectors of the following layer are offset relative to the first irradiation vectors of the (previous) layer, preferably linearly or translationally.

Under the premise that the vectors or other manufacturing parameters are already provided in preparation for the process, the corresponding first irradiation vectors of the layer can also be offset relative to the following layer. Such an offset can be adapted and tailored individually according to the design requirements of the structural part and a thermal load situation and advantageously allows tailored cooling, even of individual regions of the structural part.

In one configuration, the first irradiation vectors of the following layer are twisted or rotated relative to the first irradiation vectors of the (previous) layer. This is expedient and/or advantageous in particular in the case of rotationally symmetric or cylindrical structural parts when choosing a curved or circular irradiation course.

In one configuration, an irradiance or a radiation density of the first irradiation vectors is reduced—e.g. relative to a standard set of parameters for forming a solid material structure. A porous structure of the layer or of a corresponding structural part cross section can be brought about, generated or provoked by these measures in a particularly advantageous manner.

In one configuration, an irradiation speed of the first irradiation vectors is increased relative to standard parameters for forming a solid material structure. A porous structure of the layer or of a corresponding structural part cross section of the structural part can likewise be brought about particularly advantageously by this measure.

In one configuration, second irradiation vectors are provided for irradiating the layer to be additively manufactured and/or in the following layer to be additively manufactured, which bring about a dense structure of the corresponding layer or of the corresponding structural part region. In the present case, a dense structure is preferably intended to refer to a largely non-porous structure, in particular a solid material. Advantageously, with this configuration, the structural part can be provided with sufficient mechanical stability or correspondingly with structure properties that are deliberately not permeable.

In one configuration, the first irradiation vectors represent a plurality of parallel irradiation vectors of a (each) layer for the structural part which, according to the design requirements, are to be deliberately provided with porous properties.

In one configuration, the first irradiation vectors represent a plurality of irradiation vectors of a corresponding structural part layer that run radially or radially symmetrically, wherein the first irradiation vectors of the following layer are, in particular, twisted or rotated relative to the first irradiation vectors of the layer.

In one configuration, further irradiation vectors are provided and/or used which represent a plurality of, in particular largely, concentric irradiation vectors of a corresponding layer for the structural part, and wherein the further irradiation vectors bring about an at least in part porous structure. Relative to the first irradiation vectors, other irradiation parameters can preferably be selected for the further irradiation vectors, which are nevertheless likewise expediently suitable for forming a porous structure. With this configuration, the structure of the structural part can be further varied in specific regions and accordingly be adapted to a corresponding thermomechanical load situation.

In one configuration, the further irradiation vectors for the aforementioned layer and the following layer are provided, wherein the further irradiation vectors of the following layer are being offset radially relative to the further irradiation vectors of the layer. As a result of this configuration, the structure variance or degrees of freedom of its permeability properties of the structural part can further advantageously be increased.

A further aspect of the present invention relates to a method for additively manufacturing the structural part by selective laser melting, selective laser sintering, or electron beam melting.

In one configuration, the manufacturing instructions for the layer to be additively manufactured are defined in a first structural part region of the structural part, and wherein further manufacturing instructions that are different from the aforementioned manufacturing instructions are defined in a second structural part region that differs from the first structural part region.

A further aspect of the present invention relates to a structural part which is manufacturable or manufactured—as described above, wherein the structural part is a component of the hot gas path of a turbomachine to be cooled, such as a turbine blade, a heat shield component of a combustion chamber, and/or a resonator structural part.

A further aspect of the present invention relates to a computer program or computer program product, comprising the manufacturing instructions as described above, wherein, when a corresponding program is executed by a computer, for example for controlling and/or programming a build processor and/or an irradiation apparatus of an additive manufacturing system, the computer program product causes these means to carry out the manufacturing of the structural part as described above.

Configurations, features, and/or advantages that herein relate to the method for providing manufacturing instructions or to the computer program product can further relate directly to the additive manufacturing method or the structural part or to an application having it, such as a turbomachine, and vice versa.

The term “and/or” used here, when used in a series of two or more elements, means that any of the listed elements can be used alone, or any combination of two or more of the listed elements can be used.

Further details of the invention are described below with reference to the figures.

### BRIEF DESCRIPTION OF THE DRAWINGS

FIG. 1 uses a schematic illustration to indicate a powder-bed-based additive manufacturing method.

FIG. 2 indicates a schematic perspective view of courses of a cooling fluid flow in a structural part and also individual layers thereof that are to be solidified.

FIG. 3 shows a schematic plan view of irradiation vectors for a layer to be additively manufactured.

FIG. 4 shows a schematic plan view of irradiation vectors for a following layer to be additively manufactured.

FIG. 5 indicates on the left—similarly to FIG. 2—a schematic lateral or sectional view (XZ-plane) of flow courses in a structural part. In the right part of the illustration, a layer profile and an offset of the irradiation paths are indicated.

Analogously to FIG. 5, FIG. 6 indicates a schematic lateral or sectional view (YZ-plane) of flow courses in a structural part.

FIG. 7 shows a schematic plan view of irradiation vectors running radially.

FIG. 8 shows a schematic plan view of irradiation vectors running radially and concentrically.

Similarly to FIG. 8, FIG. 9 shows a schematic plan view of irradiation vectors for a layer to be additively manufactured.

FIG. 10 shows a schematic plan view of irradiation vectors for a layer to be additively manufactured following the aforementioned layer.

FIG. 11 shows a schematic perspective view of a rotationally symmetric structural part portion with flow paths running in part longitudinally and circumferentially.

Similarly to FIGS. 9 and 10, FIGS. 12 and 13 indicate a radial offset of concentrically running irradiation courses of layers to be additively manufactured that follow one after the other.

Analogously to FIG. 11, FIG. 14 shows a corresponding perspective view of a structural part portion according to FIGS. 12 and 13.

FIG. 15 indicates a radial section of the structural part according to the embodiment shown in FIGS. 12 to 14.

### DETAILED DESCRIPTION OF INVENTION

In the exemplary embodiments and figures, elements that are identical or have the same effect can each be provided with the same reference signs. The elements shown and their proportions to one another are fundamentally not to be regarded as true to scale; rather, individual elements can be shown exaggeratedly thick or with large dimensions for better presentability and/or for better understanding.

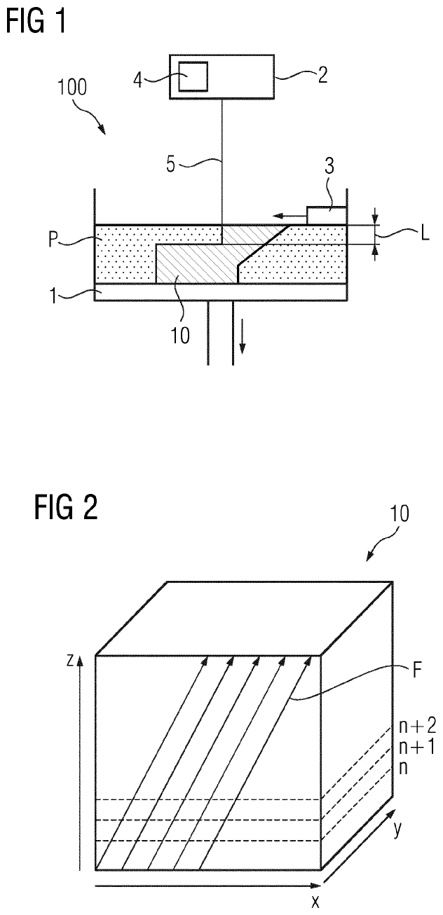

FIG. 1 indicates steps of an additive manufacturing process of a structural part 10 with reference to a manufacturing system 100 shown in simplified form.

The manufacturing system 100 is preferably designed as an LPBF system and for the additive buildup of structural parts or components from a powder bed, in particular for selective laser melting. The system 100 can in particular also relate to a system for selective laser sintering or electron beam melting. Accordingly, the system has a build platform 1. A structural part 10 to be additively manufactured is created layer by layer from a powder bed on the build platform 1. The powder bed is formed by a powder P, which can be distributed layer by layer on the build platform 1 by a coating device 3.

After each layer L of powder P has been applied with a layer thickness, regions of the layer L are selectively melted with an energy beam 5, for example a laser or electron beam, from an irradiation device 2 and then solidified according to the specified geometry of the structural part 10.

The system 100 preferably has an irradiation apparatus 2 for irradiating the powder layers L with an energy beam 5.

After each layer L, the build platform 1 is preferably lowered by an amount corresponding to the layer thickness L (cf. the downwardly pointing arrow in FIG. 1). The thickness L is usually only between 20 and 40 μm, so that the entire process easily requires a number of thousands to several tens of thousands of layers.

The geometry of the structural part 10 is usually defined by a CAD file (“computer-aided design”). After such a file has been read into the manufacturing system 100, the process then first requires the definition of a suitable irradiation strategy, for example by means of CAM (“computer-aided manufacturing”), as a result of which the structural part geometry is also divided into the individual layers. This can be carried out or implemented by a corresponding build processor 4 using a computer program.

The structural part 10 is preferably a coolable component of the hot gas path of a turbomachine that it to be cooled during operation, such as a turbine blade, heat shield component of a combustion chamber, and/or a resonator component, for example a Helmholtz resonator.

Alternatively, the structural part 10 may be a ring segment, a burner part or a burner tip, a frame, a shield, a heat shield, a nozzle, a seal, a filter, an orifice or lance, a stamp or an agitator, or a corresponding transition, insert, or a corresponding retrofit part.

In order to implement or process manufacturing instructions for the buildup of the structural part (see further below), for example based on a specified CAD geometry of the structural part, the aforementioned build processor 4 or a corresponding circuit is provided which can be programmed, for example, with corresponding CAM information or manufacturing instructions and/or can correspondingly cause the irradiation apparatus 2 to build up the structural part layer by layer in accordance with the manufacturing instructions described further below. The build processor circuit 4 preferably acts as an interface between the software that prepares the actual build process and the corresponding hardware of the manufacturing system 100. For this purpose, the build processor can be set up, for example, to execute a computer program (cf. computer program product CPP) with corresponding manufacturing instructions.

Methods for providing manufacturing instructions for the powder-bed-based additive manufacturing of the structural part 10 comprise, according to the invention, providing first irradiation vectors V1 for a layer n to be additively manufactured (see figures further below), which, when correspondingly irradiated by the energy beam 5, bring about a porous structure of the layer n. The method furthermore comprises providing the first irradiation vectors V1 for a layer n+1 to be additively manufactured following layer n in such a way that paths 11 of a porous structure 12 of the layer n and of the following layer n+1 at least partially overlap in a layer plane in order to allow flow through the manufactured structural part along and/or obliquely to its build-up direction Z.

FIG. 2 indicates a perspective view of a structural part or a structural part portion which can be built up additively layer by layer. The dashed lines distinguish individual structural part layers. The arrows running diagonally or obliquely denoted by the reference sign F are intended to indicate a corresponding direction of flow, according to which a cooling fluid can expediently flow through the structural part portion for cooling during intended operation.

According to the illustration, the direction of flow F runs at least partially in the XZ-plane and is slightly inclined relative to the build-up direction Z. In order to ensure such through-flow capacity or permeability of the structural part, a scanning or irradiation strategy according to the invention must already be defined in advance.

In particular, such a functionality with a porosity or permeability running diagonally or obliquely to the build-up direction Z can no longer be achieved by way of irradiation parameters that are of the same type layer by layer or are arranged in the same way layer by layer, but rather an offset of irradiation vectors with correspondingly selected or varied irradiation parameters is preferably required.

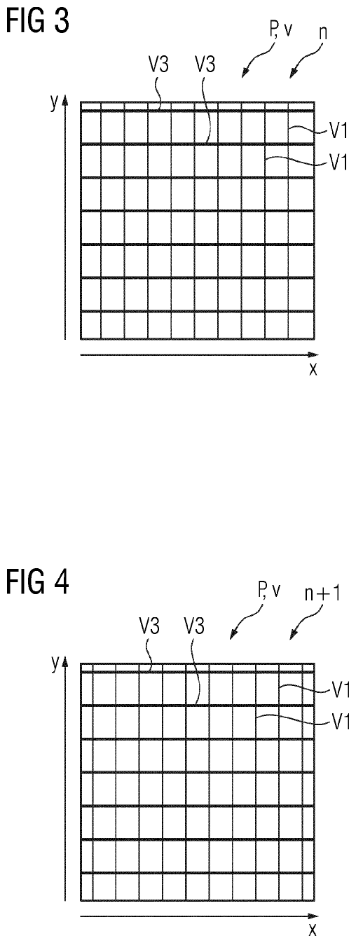

To achieve a porous structure in the described cooling passages or channels, for example, an irradiance P of the first irradiation vectors V1 can be reduced and/or an irradiation speed v thereof can be increased relative to standard parameters for forming a solid material structure. This is indicated in FIG. 3 and the following figures.

FIG. 3 shows the first irradiation vectors V1 (vertical), which bring about the functional porosity. These are arranged in a grid-like manner only as an example. According to the illustration in FIG. 3, the first irradiation vectors V1 comprise a plurality of parallel irradiation vectors of a given layer n for the structural part 10. The layer n can mean any layer in the layer construction of the structural part.

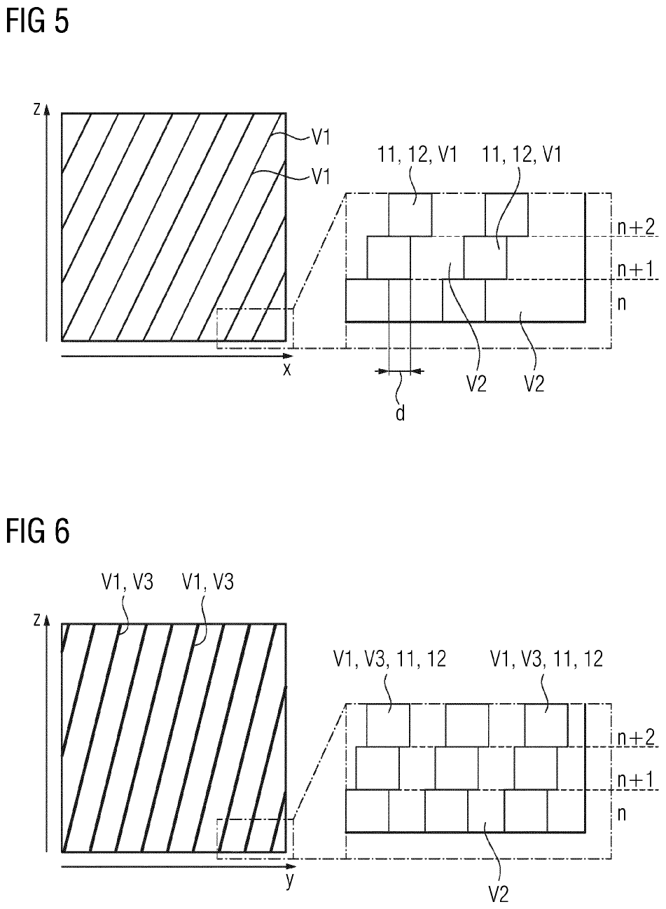

In addition, second irradiation vectors V2 can be provided for irradiating the layer n to be additively manufactured and/or in the following layer n+1 to be additively manufactured (cf. FIG. 4 further below), which bring about a dense structure of the corresponding layer, in particular a solid material. This is indicated in FIG. 3 by the background. Such a dense structure is usually expedient for reasons of stability or for the dimensional stability of the structural part 10.

Moreover, further, third irradiation vectors V3 can be provided (horizontally) in the manner of a grid. These vectors V3 can likewise bring about a porous structure in the structural part portion, for example a different type of porous structure with a differently dimensioned porosity, of the corresponding layer.

Irradiation according to the first irradiation vectors V1 and the further irradiation vectors V3 can, for example, each involve a porosity of between 5% and 40%, preferably of about 20%.

FIG. 4 schematically shows—analogously to FIG. 3—a plan view of a structural part layer n+1 following that shown in FIG. 3, or a corresponding raw powder layer. The arrangement of the first irradiation vectors V1 shows a linear offset of these irradiation vectors relative to layer n (cf. FIG. 5).

This offset allows the permeability profiles shown in FIG. 5 to form obliquely to the build-up direction (cf. also FIG. 2). In the left-hand part of the illustration, FIG. 5 shows a lateral view of the structural part portion in the XZ-plane with paths 11 running diagonally in the structure of the structural part, which are intended to indicate a cooling or flow path.

In the right-hand part of the illustration in FIG. 5, the situation is shown enlarged for three successive layers n, n+1 and n+2. It can be seen that the structure paths 11 solidified by the first irradiation vectors V1 in the course of the additive manufacturing process are offset layer by layer by the amount d in order to produce the diagonal or oblique profile.

In other words, the scanning strategy introduced is based on a shift of the irradiation vectors in a preferred direction in order to promote the formation of the cavities or flow paths to be flowed through. If, for example, a flow is to occur, as in the example shown, at an angle of more or less than 90° relative to the XY- or layer plane, i.e. at least partially along the Z-direction, a vector V1 in the layer n+1 is translationally shifted by the amount d along the positive X- or Y-direction. The amount d determines here the desired angle that the course of the flow paths should form with respect to the build-up direction Z.

As an alternative to this arrangement, an offset can also be dispensed with completely in order to achieve an exactly vertical course of the paths 11 (not explicitly marked).

Analogously to FIG. 5, FIG. 6 indicates a situation in the other lateral direction, the Y-direction, relative to the build-up direction Z.

On the left is again shown a lateral view of the structural part portion in the YZ-plane with diagonally running paths 11 in the structure of the structural part, which are intended to indicate a through-flow.

In the right-hand part of the illustration in FIG. 6, the situation in the layer cross section is again indicated. Without restricting generality, an offset d similar to that shown in FIG. 5 is indicated here, so that overall a uniform diagonally oblique course of the paths 11 results for the structural part 10.

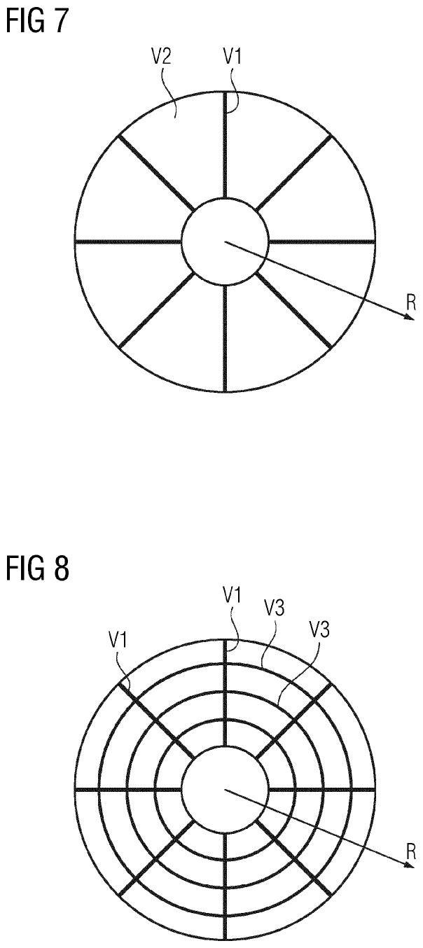

FIG. 7 shows a plan view of a circular manufacturing area or a round layer region. A radial direction is marked starting from a central region with an arrow and the reference sign R. First irradiation vectors V1 of a corresponding irradiation pattern are arranged or provided along R—in the present case arranged radially symmetrically only by way of example—in order to form a porous layer structure. After manufacturing, this advantageously again allows a radial through-flow of a fluid F and a correspondingly achievable cooling in the structural part.

The aforementioned first irradiation vectors V1 run uniformly at a distance of a polar angle. Contrary to what is shown, this angular distance can of course also vary between individual vectors V1.

Furthermore, second irradiation vectors—for forming a dense material structure of the layer—are designated. These vectors V2 signify the remaining layer structure and—for the sake of clarity—are shown without individual irradiation paths.

In particular in the case of rotationally symmetric structural parts or structures, scan vectors according to FIG. 7 can be provided.

In addition to this, a plurality of further, concentrically arranged irradiation vectors V3 are indicated in FIG. 8, which likewise bring about an at least in part porous structure of one of the layers. This is so that, for example, a cooling effect can also be brought about in the circumferential direction if the structural part is intended to be flowed through and cooled accordingly during operation.

In FIG. 8, the stated irradiation vectors V1 running radially are supplemented by concentric tracks or profiles V3, which run at a radial distance from one another and can form both a closed and an interrupted profile. This applies equally to the other irradiation vectors described. The permeability for a cooling fluid F can be achieved, for example, by omitting layers and reducing their introduced energy. For example, open sites, which allow a corresponding permeability, can also be provided in a targeted manner.

For other applications, an impermeable “wall” can in contrast be provided—for example in sectors—if the structural part 10 or the corresponding structural part region is to be cooled only in the Z-direction, for example.

If the vectors are now adapted or shifted from layer to layer, similarly to the embodiments described above, a three-dimensional through-flow can likewise be made possible. This is indicated in the following figures.

FIG. 9 shows, for a given layer n, an irradiation pattern already described with reference to FIG. 8, comprising the first, second and further, third irradiation vectors V1, V2 and V3.

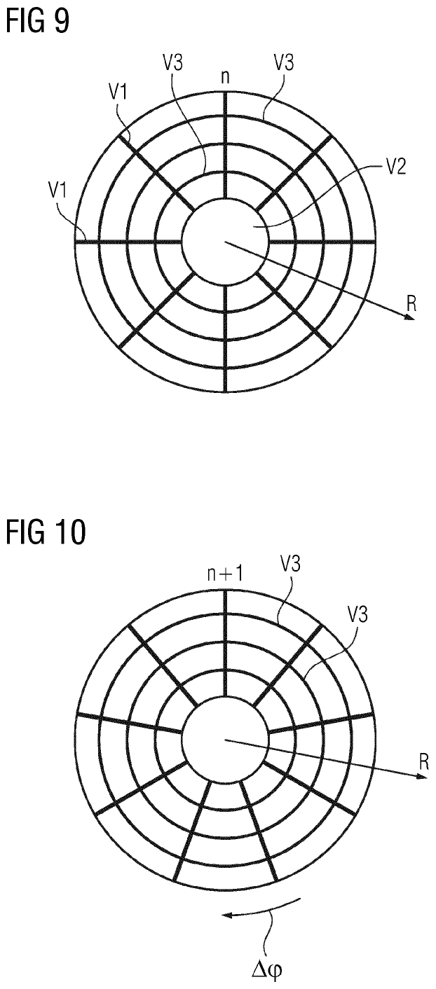

FIG. 10 shows the situation again for a—preferably immediately—following layer n+1. It can be seen that the first irradiation vectors V1 of the following layer n+1 have been twisted clockwise by a small angle Ay relative to the first irradiation vectors V1 of the layer n. With this configuration of the present invention, the through-flow capacity and cooling effect can likewise be tailored in an advantageous manner and decisively improved locally.

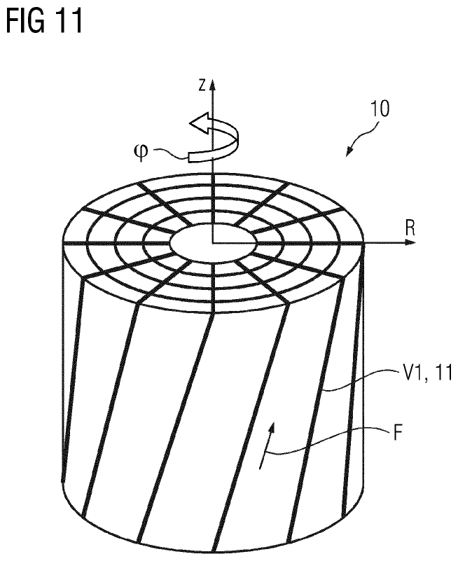

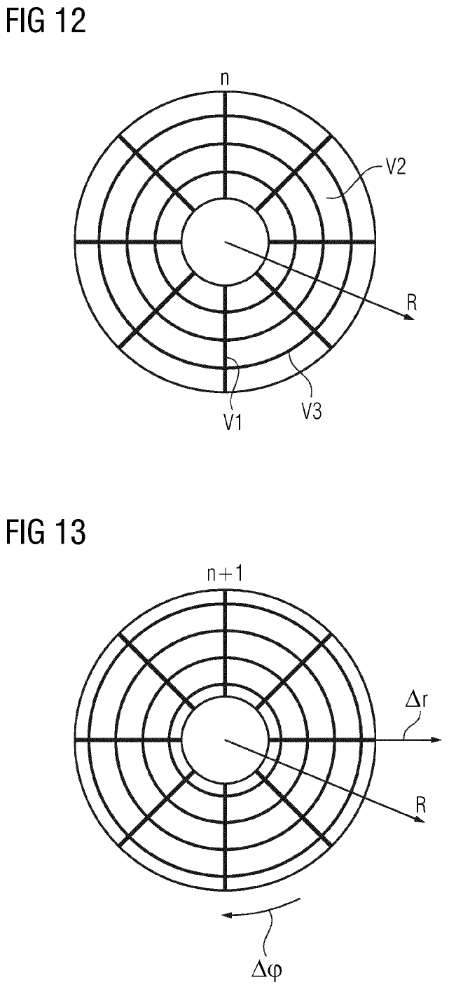

FIG. 11 shows a perspective schematic view of a cylindrical or approximately rotationally symmetric structural part structure which can be manufactured according to an irradiation pattern according to FIGS. 9 and 10. In this case, the first irradiation vectors V1 were in each case twisted or rotationally offset, layer by layer, so that the paths 11 of the structural part 10 that are shown and run obliquely relative to the build-up direction Z can be manufactured. According to the illustration in FIG. 11, a counterclockwise twist is shown.

FIGS. 12 to 14 moreover indicate that, in addition to twisting the flow-active paths (cf. V1) in the structural part 10, a whirlpool effect (cf. irradiation vectors V3) or eddy-like through-flow and cooling can also be achieved. For this purpose, the concentric tracks can be provided layer by layer, for example, with a radial offset (cf. Ar), and thus a correspondingly improved through-flow and cooling can be specified over the entire structural part. This is shown in particular in FIG. 13 for the layer n+1.

The radial offset can also be provided without a polar offset, and vice versa.

FIG. 14 shows a perspective schematic view of the structural part 10 with both a radial and a polar offset of the porosity-creating irradiation vectors V1 and V3.

Such a scanning or irradiation strategy could, for example, be used to supply a lubricant to a structural part region or to a bearing in the Z-direction, and then can evenly transfer to a shaft both circumferentially and over the length and radius of the bearing.

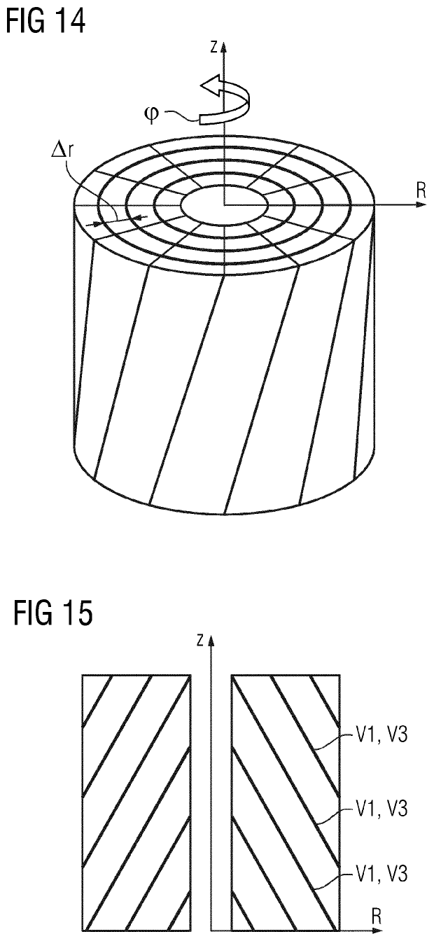

A radial or longitudinal section of the structure from FIG. 14 is shown in FIG. 15, where in particular the concentric and longitudinal flow paths are oriented slightly obliquely to the Z-direction due to the radial offset layer by layer (cf. FIGS. 12 and 13).

The irradiation strategies introduced advantageously allow a tailoring of cooling or heat dissipation properties of thermally highly loaded structural parts in general. Of course, the thermal properties could likewise be adapted and improved only with respect to local or individual regions of the component with the solutions introduced.

1.-14. (canceled)

15. A method for providing manufacturing instructions for powder-bed-based additive manufacturing of a structural part, comprising:
providing first irradiation vectors (V1) for a layer (n) to be additively manufactured, which upon corresponding irradiation by an energy beam bring about a porous structure of the layer, and
providing the first irradiation vectors (V1) for a layer (n+1) that follows the layer (n) and is to be additively manufactured in such a way that paths of a porous structure of the layer (n) and of the following layer (n+1) at least in part overlap in order to allow flow through the manufactured structural part along a build-up direction (Z) of the structural part (10),
wherein the first irradiation vectors (V1) of the following layer (n+1) are twisted (φ) relative to the first irradiation vectors (V1) of the layer (n),
wherein the first irradiation vectors (V1) of the layer (n) and of the following layer (n+1) overlap in a layer plane by an amount that is smaller than a lateral extent of the paths, and
wherein second irradiation vectors (V2) are provided for irradiation of the layer (n) to be additively manufactured and/or in the following layer (n+1) to be additively manufactured, which bring about a dense structure of the corresponding layer.

16. The method as claimed in claim 15,
wherein the first irradiation vectors (V1) of the following layer (n+1) are offset (d) relative to the first irradiation vectors (V1) of the layer (n).

17. The method as claimed in claim 15,
wherein an irradiance (P) of the first irradiation vectors (V1) is reduced and/or an irradiation speed (v) thereof is increased relative to standard parameters for forming a solid material structure.

18. The method as claimed in claim 15,
wherein the first irradiation vectors (V1) represent a plurality of parallel irradiation vectors of each layer for the structural part.

19. The method as claimed in claim 15,
wherein the first irradiation vectors (V1) represent a plurality of radially or radially symmetrically running irradiation vectors of each layer for the structural part, and
wherein the first irradiation vectors (V1) of the following layer are twisted (φ) relative to the first irradiation vectors of the layer.

20. The method as claimed in claim 19,
wherein further irradiation vectors (V3) are provided which represent a plurality of concentric irradiation vectors of each layer for the structural part, and
wherein the further irradiation vectors (V3) bring about an at least in part porous structure of each layer.

21. The method as claimed in claim 20,
wherein the further irradiation vectors (V3) for the layer (n) and for the following layer (n+1) are provided, and
wherein the further irradiation vectors (V3) of the following layer are offset radially relative to the further irradiation vectors (V3) of the layer.

22. The method as claimed in claim 15,
wherein the method is a Computer-Aided-Manufacturing (CAM) method.

23. A method of additively manufacturing the structural part by selective laser melting or electron beam melting, comprising:
implementing the manufacturing instructions as claimed in claim 15.

24. The method as claimed in claim 23,
wherein the manufacturing instructions for the layer to be additively manufactured are defined in a first structural part region of the structural part, and
wherein further manufacturing instructions which are different from the manufacturing instructions are defined in a second structural part region which is different from the first structural part region.

25. A structural part manufactured according to the method as claimed in claim 23,
wherein the structural part is a component of a hot gas path of a turbomachine that is to be cooled, a turbine blade, a heat shield component of a combustion chamber, and/or a resonator structural part.

26. A non-transitory computer readable medium comprising a computer program product stored thereon, comprising:
manufacturing instructions for powder-bed-based additive manufacturing of a structural part, wherein the manufacturing instructions implement the method as claimed in claim 1 when executed by a computer.

27. The non-transitory computer readable medium of claim 26,
which, when executed by a computer, control and/or program a build processor and/or an irradiation apparatus of an additive manufacturing system, to cause the computer to carry out the manufacture of a structural part, wherein the structural part is a component of a hot gas path of a turbomachine that is to be cooled, a turbine blade, a heat shield component of a combustion chamber, and/or a resonator structural part.

28. The method as claimed in claim 15,
wherein the energy beam comprises a laser or electron beam.
